(19) United States
(12) Patent Application Publication
(10) Pub. No.: US 2026/0365510 A1
(43) Pub. Date: Nov. 19, 2026

(54) Plasma-catalyzed direct water-gas shift reaction

(71) Applicant: ENERGO, HELLEMES-LILLE (FR)

(72) Inventors: Maria MIKHAIL, LILLE (FR); Johnny ABBOUD, LILLE (FR)

(73) Assignee: ENERGO, HELLEMES-LILLE (FR)

(21) Appl. No.: 19/148,311

(22) PCT Filed: Feb. 1, 2024
(86) PCT No.: PCT/EP2024/052549

§ 371 Date: Jul. 15, 2025

(30) Foreign Application Priority Data
Feb. 2, 2023 (FR) 2300958

(51) Int. Cl. C01B 3/16; B01J 23/10; B01J 23/83; B01J 35/30; B01J 37/34

(52) U.S. Cl. CPC C01B 3/16; B01J 23/10; B01J 23/83; B01J 35/394; B01J 37/349

(57) ABSTRACT

The present invention relates to a method for chemically converting a gas mixture comprising carbon monoxide (CO) and water vapour (H₂O) according to the following WGS reaction: CO+H₂O→CO₂+H₂ in the presence of a catalytic system, also called catalyst, activated by cold plasma (for example generated by DBD dielectric barrier discharge). It also concerns a catalyst as well as the use of such a catalytic system, activated by cold plasma, to produce molecules with high value added, such as hydrogen (H₂).

### TECHNICAL FIELD

The present invention relates to the field of chemical conversion, in particular the chemical conversion of carbon monoxide (CO) and water vapour (H₂O) using the following WGS reaction: CO+H₂O→CO₂+H₂ in the presence of a catalyst activated by a cold plasma, for example generated by “dielectric barrier discharge”, known as DBD. The invention relates in particular to said conversion method, said catalytic system, and the use of such a catalyst in order to produce high value added molecules, such as hydrogen (H₂).

### STATE OF THE ART

Hydrogen is a clean alternative to conventional fossil fuel-based energy sources. It is considered to be the ideal energy choice for the development of a sustainable future.

The water-gas shift (WGS) reaction is a method of choice for increasing the hydrogen (H₂) content of a synthesis gas. This process is normally deployed after steam reforming or partial oxidation of natural gas or coal to produce a hydrogen-rich synthesis gas [1].

The WGS reaction (see Equation 1) is reversible and slightly exothermic. It is sensitive to temperature variations. Too high a temperature significantly increases the reaction rate but fosters the “Reverse Water Gas Shift” or “RWGS reaction” which is endothermic (see Equation 2), which limits the conversion rate. A compromise must therefore be found between the reaction rate (high temperature) and the conversion rate (low temperature) [1], [2].

CO+H₂O→CO₂+H₂; ΔH°=−41.09 KJ/mol (Eq.1)

CO₂+H₂→CO+H₂O; ΔH°=41.09 KJ/mol (Eq.2)

Owing to thermodynamic constraints, the WGS reaction is normally carried out in two separate reactors: a high temperature shift reactor (HTS) and a low temperature shift reactor (LTS) [1], [2]. According to this approach, kinetics are favoured in the first reactor owing to the high temperature, while thermodynamics are favoured in the low temperature shift reactor, resulting in a high H₂ yield.

In general, the WGS reaction is carried out on iron oxide-based catalysts in the high temperature region (HTS)(>300 °C), followed by the reaction on copper-based catalysts in the low temperature region (LTS)(200-250 °C), in order to optimise the process from a kinetic and thermodynamic point of view. The coupling of HTS and LTS methods requires careful process design, including the use of heat exchangers for thermal regulation of reaction flows, which entails high investment and operating costs [1], [2], [3].

In addition, under WGS reaction conditions, catalyst deactivation due to metal sintering and carbonisation is also problematic, reducing the efficiency of the method and increasing operating costs.

Activation of reagents via non-thermal plasma (NTP) assisted by the WGS reaction with a catalyst is one of the possibilities for solving the issues of the prior art. The few studies that have been carried out to date are not satisfactory in terms of stability, efficiency and cost, which limits the use of the system for an industrial application [4], [5], [6], [7].

The purpose of the present invention is notably to provide a method for chemically converting carbon monoxide (CO) and water vapour (H₂O) according to the following WGS reaction: CO+H₂O→CO₂+H₂ in the presence of cold plasma and a catalyst that has high catalytic and energy yields, said process capable of being exploited on a large scale. In particular, said catalyst comprises:
at least one carrier comprising cerin or cerium oxide,
at least one first promoter comprising copper, and
at least one second promoter selected from the group consisting of transition metals, post-transition metals, lanthanides, and mixtures thereof.

The patent applications and patent [9-12] do not describe such a plasma-catalysed conversion method wherein the catalyst is activated by cold plasma.

### SUMMARY OF THE INVENTION

A first object of the present invention is a method for chemically converting a gas mixture comprising carbon monoxide (CO) and water vapour (H₂O) according to the following WGS reaction: CO+H₂O→CO₂+H₂ in the presence of a catalyst, also called a catalytic system, comprising at least one carrier comprising cerin or cerium oxide, at least one first promoter comprising copper, and at least one second promoter selected from the group consisting of transition metals, post-transition metals, lanthanides, and mixtures thereof, activated by cold plasma. According to one embodiment, the cold plasma is a plasma generated by dielectric barrier discharge (DBD).

A second object of the present invention is a catalyst, also called a catalytic system, for converting, preferably in a single step, a gas mixture comprising CO and water vapour into H₂. This catalyst, which can for example be activated by cold plasma before being brought into contact with the gas mixture to be converted, for example generated by dielectric barrier discharge DBD. The catalyst of the present invention is such that it comprises at least one cerin carrier and at least two promoters, one of which comprises copper. The use of such a catalyst combined with a cold plasma for the conversion of gases in the WGS reaction makes it possible to overcome all the drawbacks of the prior art present in the thermal method (coupling of the HTS and LTS processes) and capable of synthesising hydrogen directly from CO and water vapour under atmospheric conditions with a high yield compared to the studies described in the prior art. In addition, the catalyst is resistant to pollutants, unlike a thermal method which is particularly vulnerable to pollutants. Furthermore, it takes up 10 to 50 times less space due to the use of a smaller quantity of catalyst than catalytic systems used in conventional methods. In addition, it uses less expensive materials compared to thermal methods, which often use noble, rare precious materials such as gold or platinum (Pt).

More specifically, said catalyst comprises:
a carrier comprising cerin or cerium oxide,
at least one first promoter comprising copper, and
at least one second promoter selected from the group consisting of transition metals, post-transition metals, lanthanides, and mixtures thereof.

A third object of the present invention relates to the use of a cold plasma activated catalyst for converting a gas mixture comprising carbon monoxide (CO) and water vapour (H₂O) according to the WGS reaction, said catalyst comprising at least one carrier comprising cerin or cerium oxide, at least one first promoter comprising copper, and at least one second promoter selected from the group consisting of transition metals, post-transition metals, lanthanides, and mixtures thereof, activated by cold plasma.

The present invention makes it possible to overcome all the drawbacks of traditional thermal catalysis methods, as described in the prior art, and thus obtain high catalytic and energy yields, and is thus capable of being exploited on a large scale. While the WGS conversion methods of the prior art have a high inertia (which can reach 24 hours for example in the context of large installations) because the reactors must be brought to high temperatures, for example in the range of 350 °C-500 °C and up to 80 bars pressure, the method of the present invention on the contrary has a high flexibility and robustness, due to its speed of implementation which not only allows the conversion reaction to be started quickly, but also accepts variations in ratios in the incoming gases while maintaining an average conversion yield much higher than the methods of the prior art.

### DESCRIPTION OF THE FIGURES

Other features, purposes and advantages of the invention will emerge from the following description, which is purely illustrative and not exhaustive, and which should be read in relation to the appended drawings:

FIG. 1 PFD block diagram for the WGS reaction. DBD type plasma catalysis reactor for the chemical conversion of a gas mixture comprising carbon monoxide (CO) and water vapour (H₂O) according to the following WGS reaction: CO+H₂O→CO₂+H₂. [FIG. 1] illustrates the experimental device (PFD diagram) used in an example, the water-gas shift (WGS) reaction, by a DBD plasma process coupled to a catalyst (also referred to as equivalent catalyst) according to one embodiment of the present invention.

[Tables 1-2] Tables illustrating the catalytic activity of several catalysts tested in the presence or absence of DBD plasma. The tables show in particular the results of the catalytic activity obtained in terms of conversion and selectivity.

### DEFINITIONS

The expression “between . . . and . . . ” (for example, a range of values) should be understood to include the limits (for example, the limit values of this range of values).

Any description in connection with an embodiment is applicable and interchangeable with all other embodiments of the invention.

The expression “and/or” shall be understood to mean “and” and “or”; for example, the expression “A and/or B” covers three alternatives and shall be understood to mean either A and B, or only A, or only B.

The expression “N, M and/or P” shall be understood to mean “N and/or M and/or P”.

The expression “N, M and P” shall be understood to mean “N and M and P”.

When an element or component is included in and/or selected from a list of elements or components, it should be understood that such individual element or component may be selected and combined with other individual elements, or may be selected to constitute a subset of two or more explicitly listed elements or components; also, any element or component cited in a list of elements or components may be omitted from that list.

The term “DBD-Dielectric Barrier Discharge” means, in the present invention, an electrical discharge created between two electrically conductive elements separated by one or more dielectric elements.

The term “dielectric” means, in the present invention, an electrical insulating material that makes it possible to ensure electrical insulation between the high-voltage network associated with the electrode and the electrically and thermally conductive tube connected to earth via the reactor. This type of electrical insulating material is also used inside the DBD cell in order to generate a plasma by Dielectric Barrier Discharge (DBD) by fostering the accumulation of electrical charges on the surface of this material.

The term “catalyst” or “catalytic system” means, in the present invention, a material promoting the chemical reaction of reactive species, for example reagent fluids.

The term “plasma-catalysis” means, in the present invention, the coupling of a plasma electric discharge and a catalyst. For example, the conversion method implements an electrical discharge of plasma coupled to a catalyst.

The term “cold plasma” or “non-thermal plasma (NTP)” refers to a plasma where the distribution of particles (electrons and ions) does not obey a Maxwell-Boltzmann thermal distribution, meaning that the electron temperature is significantly higher than the ion temperature, so that the kinetic energy of the ions is much lower than that of the electrons. This type of plasma is often characterised by the presence of a population of highly energetic electrons, while the ions remain at lower energies, hence the term “non-thermal plasma” [13]. Dielectric barrier discharge (DBD) is an example of cold or non-thermal plasma, wherein the gas is more or less at room temperature, and the average energy of the electrons is between 2 and 5 eV due to the strong electrical field in the plasma [14]. The gas temperature remains close to ambient temperature. This can be controlled using a heat exchanger system (circulation of a heat transfer fluid) capable of maintaining a constant temperature, thus ensuring control of the system in the event of an exothermic or endothermic reaction. In the context of the present invention, in the case of an exothermic reaction, the temperature of the gas can be controlled so that it is less than 300 °C, for example less than 280 °C or 270 °C. If necessary, the temperature of the gas can be measured by a probe (thermocouple) and the temperature of the electron by Optical Emission Spectroscopy.

In the context of the present invention, the terms “Water Gas Shift”, “WGS” and “WGS reaction” mean the direct conversion reaction of gas to water according to equation 1.

The term “hydrogen” should be understood to mean “dihydrogen” or “H₂”.

The term “carrier” or “catalyst carrier” means, in the present invention, a solid material or a mixture of solid materials characterised by a high specific surface area, on which the promoter(s) are deposited.

The term “promoter” or “catalyst promoter” in the present invention means a solid material or mixture of solid materials added to the surface of the carrier material, generally in small amounts, for the purpose of increasing the efficiency and performance of the catalyst.

Of course, the invention is described in the foregoing as example. It should be understood that a person skilled in the art is capable of carrying out different variants of the invention yet without departing from the scope of the invention.

### DETAILED DESCRIPTION OF THE INVENTION

### Method for Converting a Gas Mixture Comprising Carbon Monoxide (CO) and Water Vapour (H₂O) According to the WGS Reaction

A first object of the present invention relates to a method for converting a gas mixture comprising carbon monoxide (CO) and water vapour (H₂O) according to the following WGS reaction: CO+H₂O→CO₂+H₂ in the presence of cold plasma and a catalyst, the latter being activated by cold plasma, preferably a plasma generated by dielectric barrier discharge (DBD), before starting the gas species conversion reaction. Said catalyst comprises at least one carrier comprising cerin or cerium oxide, at least one first promoter comprising copper (in metallic or oxide form) and at least one second promoter selected from the group consisting of transition metals, post-transition metals, lanthanides, and mixtures thereof, activated by cold plasma (each being independently in metallic or oxide form). The aim of this method is to produce, in a single step, molecules with high value added, such as hydrogen (H₂).

The gas mixture to be converted according to the WGS reaction comprises carbon monoxide (CO) and water vapour (H₂O). It may further comprise other gases, such as for example carbon dioxide (CO₂), methane (CH₄), nitrogen (N₂), oxygen (O₂) and/or dihydrogen (H₂). According to one embodiment of the present invention, the gas mixture to be converted according to the WGS reaction comprises mainly carbon monoxide (CO) and water vapour (H₂O), and optionally one or more gases selected from the group consisting of carbon dioxide (CO₂), methane (CH₄), nitrogen (N₂), oxygen (O₂) and dihydrogen (H₂), and mixtures thereof. According to this embodiment, the gas mixture to be converted according to the WGS reaction comprises for example more than 50 mol. % of carbon monoxide (CO) and water vapour (H₂O), for example more than 60 mol. %, more than 70 mol. %, more than 80 mol. %, more than 90 mol. %, more than 95 mol. % or even more than 98 mol. %, relative to the total number of moles involved in the WGS conversion reaction according to the invention.

The method for converting a gas mixture comprising carbon monoxide (CO) and water vapour (H₂O) according to said WGS reaction (Eq. 1) is carried out in the presence of the catalyst of the present invention, as well as a cold plasma, preferably a plasma generated by dielectric barrier discharge (DBD). The synergy of catalysis by plasma in this method shows great potential for the direct synthesis of hydrogen, a high value added gas, from CO and water vapour.

The conversion method of the present invention comprises a first step of activating the catalyst by cold plasma, before feeding the reactor with the gas mixture to be converted. The catalyst according to the invention is activated by cold plasma, i.e. it is advantageously reduced in situ under cold plasma, preferably DBD plasma, under H₂ as discharge gas. The step of activating the catalyst is particularly advantageous in the case where its components are in oxide form.

The conversion method of the present invention is carried out within a cold plasma reactor, preferably a DBD plasma reactor. The catalyst is typically placed between the electrodes of the cold plasma reactor, before being activated by electrical discharges leading to the formation of cold plasma and thus to the negative or positive polarisation of the catalytic sites of the catalyst. The gas mixture to be converted is then introduced into the reactor and flows between the reactor electrodes for conversion according to the WGS reaction. The WGS conversion reaction is performed under cold plasma.

According to one embodiment of the method of the invention, said conversion is carried out in the presence of cold plasma at temperatures below 300 °C, below 290 °C, below 280 °C or even below 270 °C.

The conversion method may in particular be of the continuous or semi-continuous type, the introduction of the gas mixture to be converted and the extraction of the products of the reaction being each carried out under continuous or semi-continuous gas flow depending on the availability of the energy, which represents an advantage in the method described in this invention given the flexibility of the system and the instantaneous character of the reaction.

According to one embodiment of the method of the invention, the selected catalyst is placed between the electrodes of a DBD reactor, allowing the gaseous species to flow through the catalyst, and is activated by high voltage electrical discharges (of the order of kV) of a duration of the order of the nanosecond to the microsecond. This polarisation, combined with adsorption, desorption, and catalyst/gas interaction, results in plasma formation and catalyst activation. The inventors have realised that this step of activating the catalyst is essential for the performance of the conversion process according to the invention. The electrical energy supplied to the fixed bed in the form of sinusoidal or pulsed high voltage creates multiple currents on the HV (high voltage) carrier waves, during the positive and negative polarisation. These streamers from a few hundred picoseconds to a few tenths of a nanosecond are responsible for the negative or positive polarisation of catalytic sites.

During the implementation of the method of the invention, the cold plasma is generated and a strong electrical field is created, which keeps said catalyst in an activated state, more particularly between the grains of said catalyst or in proximity, upstream or downstream of the catalytic system, in the gas stream. This strong electric field is typically between 103 and 1010 V/m, and may vary over time. When the gas mixture is then introduced into the reactor for conversion according to the WGS reaction, the cold plasma allows ionisation of part of the gas and excitation of atoms and molecules present in the gas phase. The reactor walls can typically be made of a metal material; alternatively, in the case where a DBD reactor is preferably used for the implementation of the method of the present invention, the reactor walls are made of a dielectric material such as quartz, alumina or ceramic. The reactor may advantageously be cylindrical in shape. In addition to creating a cold plasma state, the strong electric field created is responsible for the negative or positive polarisation of the catalytic sites of the catalyst. The latter is typically inserted directly into the reactor to form the catalytic bed through which the gas passes (it is typically not coated on the reactor wall in the form of layers). The structure of the catalyst (including accessibility of the catalyst's key constituents) and the selection of its constituents are essential for achieving high conversion yields, depending on the gas molecules to be converted. The polarisation of the catalytic sites of the catalyst induces adsorption and desorption reactions, essential for the performance of the method of the invention. The polarisation performance, as well as the activation of the catalytic sites necessary for the chemical reaction, the limiting steps, are possible in the presence of cold plasma, at low gas temperatures (for example below 300 °C, or below 290 °C, 280 °C or 270 °C). According to the conventional process without polarisation, the working temperature is higher, typically in the range of 350 °C to 500 °C, and requires 2 steps: LTS and HTS.

The reactor comprises at least one inlet enabling its supply of gas to be converted, comprising CO and water vapour, and an outlet for evacuating the formed products, in particular H₂.

According to one embodiment, the method of the present invention comprises the following steps in order:
a) Activating the catalyst placed between the electrodes of a cold plasma reactor, preferably a DBD plasma reactor, by generating cold plasma under H₂ as discharge gas;
b) Introduction of the gas mixture to be converted between the reactor electrodes through the catalyst;
c) Cold plasma conversion of the gas mixture according to the WGS reaction, for example continuously or semi-continuously, by circulating the gas stream between the reactor electrodes.

The method of the present invention may further comprise extracting the products of the reaction and/or recirculation in the method of the invention. In the industrial process, the hydrogen (H₂) produced will be separated from the unconverted gas mixture (CO, H₂O) and the carbon dioxide (CO₂). The mixture of unconverted reagents, carbon monoxide (CO) and water vapour (H₂O) will be reintroduced into the reactor. This results in an overall process with 100% conversion, minimising reagent loss.

According to one embodiment of the method of the invention, there is an excess of water vapour (H₂O) in relation to the carbon monoxide (CO). According to one embodiment of the method of the invention, the molar ratio of water vapour (H₂O)/carbon monoxide (CO) in the gas mixture to be converted varies between 1 and 5 (a ratio of H₂O/CO=5 means that there are 5 times more water molecules than CO molecules), for example between 1 and 4, preferably between 1 and 3, between 1 and 2.5, between 1 and 2 or between 1 and 1.5. By way of illustration, the H₂O/CO ratio can be set at 1.1±0.1, which means that it is likely to vary between 1 and 1.2 (with an excess of water vapour).

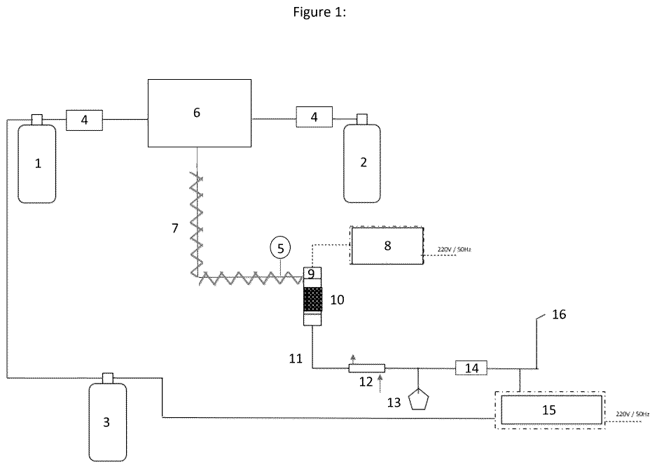

As shown in FIG. 1, the water 1 stored in a tank is first propelled by an inert gas (Ar) 3 and then flows through a mass flow controller 4. It is then vaporised and then mixed with a stream of CO (carrier gas) 2, also controlled by a mass flow meter 4, using a controlled evaporation and mixing system 6. The gaseous mixture is then transported along a heated pipe 7 equipped with a pressure gauge 5 to the inside of the DBD plasma catalytic reactor 9. That reactor comprises a catalytic bed 10 and is connected to a plasma generator 8. The product flow 11 is then directed to a water condensation system 12 and then to a condensed liquid recovery tank 13. The gas flow is measured using a volume flow meter 14. A micro GC 15 into which Argon 3 (carrier gas for micro GC) is introduced is used to analyse the composition of the gases, then the vent 16.

According to one embodiment of the invention, the catalyst of the invention is activated by a plasma DBD by providing an electrical power of less than 25 W/g of catalyst (i.e. the catalyst present in the reactor, specifically in the catalytic bed).

The conversion reaction is advantageously carried out at a pressure close to or equal to atmospheric pressure (10⁵ Pa), for example at a pressure between 1.10⁴ Pa and 3.10⁵ Pa. The conversion reaction may be performed under pseudoadiabatic conditions, i.e. without thermal insulation and without external heating, or under isothermal conditions, i.e. with thermal insulation and/or external temperature control.

According to one embodiment of the method of the invention, the DBD plasma is generated by applying a voltage between the two electrodes between 1 and 25 kV, preferably between 5 and 15 kV, and/or with a frequency between 1 kHz and 100 kHz. The gas hourly space velocity (GHSV) may in particular be between 1000 h⁻¹ and 150000 h⁻¹, preferably less than 100000 h⁻¹.

A cooling system may be present between the container intended to receive the products generated by the conversion reaction and the outlet of the reactor, so as to condense and remove the water vapour that has not reacted during the conversion reaction.

### Catalyst According to the Invention

A second object of the present invention relates to a catalyst for converting a gas mixture comprising carbon monoxide (CO) and water vapour (H₂O) according to the following WGS reaction: CO+H₂O→CO₂+H₂, said conversion being carried out in the presence of cold plasma.

More specifically, said catalyst comprises:
a carrier comprising cerin or cerium oxide,
at least one first promoter comprising copper, and
at least one second promoter selected from the group consisting of transition metals, post-transition metals, lanthanides, and mixtures thereof.

In the context of the present invention, the terms “catalytic system” and “catalyst” are equivalent and interchangeable.

According to one embodiment of the invention, said catalyst is called a bi/trimetallic catalyst. It should be noted that the notion of bimetallic or trimetallic catalyst relates in particular to the species present in the catalyst regardless of the carrier used. For example, when the catalyst is doped by two promoters, then we call it a bimetallic catalyst; when the catalyst is doped by three promoters, then we call it a trimetallic catalyst.

The carrier used in the context of the present invention is in particular chosen for its ability to adsorb the reagents and more particularly CO, for its thermal stability, and for its high specific surface area aimed at promoting the plasma-catalyst interface, which makes it possible to offer various reaction pathways in the surface chemistry. It is also chosen for its dielectric properties which can impact the properties of the plasma and modify the discharge behaviour of the plasma, in particular DBD plasma when it is used, the electric field and the electronic density due to the dielectric permittivity and the polarisation effect which gives rise to the local electric field.

According to one embodiment of the present invention, the catalyst carrier comprises cerin; in particular, the carrier may consist of cerin. According to one embodiment or use, the carrier is a cerium oxide. Thus, the catalyst carrier may further comprise other components, for example a mixed oxide and/or aluminium and/or zirconium.

According to one embodiment of the present invention, the catalyst carrier consists of cerin, and optionally alumina, each being independently in cerin/alumina form or in their corresponding oxide form.

According to this embodiment, the catalyst carrier may in particular consist exclusively of cerin and/or cerium oxide. Alternatively, the catalyst carrier may consist exclusively of cerin and/or cerium oxide, as well as alumina and/or aluminium oxide. When the catalyst carrier consists of a mixture of cerin and alumina (including in oxide form), these species may be present in a Ce/Al mass ratio varying between 10:90 and 90:10, for example 20:80 and 80:20, 40:60 and 75:25 or 50:50 and 70:30.

According to a preferred embodiment of the present invention, the catalyst carrier consists of cerin and/or cerium oxide. According to this preferred embodiment, the catalyst carrier does not comprise other constituents, or comprises an amount of other constituents not significantly impacting its properties. Thus, according to this embodiment, the catalyst carrier comprises less than 5% by weight of other constituents, less than 4% by weight of other constituents, less than 3% by weight of other constituents, less than 2% by weight of other constituents, less than 1% by weight of other constituents, or even less than 0.1% by weight of other constituents.

The choice of carrier is important as it impacts the physicochemical properties (basicity, acidity, reducibility, oxygen mobility due to the presence of inherent defects present on said surface, etc.), as well as the texture properties (porous volume, pore diameter, specific surface, etc.) and the electrical properties (permittivity, conductivity, etc.), which in turn modulate the catalytic performance of the system.

The preparation of the catalyst carrier is detailed below. The carrier used in the context of the present invention may also be a commercially available carrier.

The catalyst according to the invention makes it possible to produce high value added molecules such as hydrogen, during conversion, in particular the conversion reaction of a gas mixture comprising carbon monoxide (CO) and water vapour (H₂O) according to the WGS reaction, in the presence of a catalyst and a cold plasma, preferably a plasma generated by dielectric barrier discharge (DBD), while improving the catalytic performance of the WGS reaction, i.e. the rate of conversion of the CO and the selectivity to the desired products (hydrogen and carbon monoxide).

For this purpose, the catalyst according to the present invention comprises at least two promoters. The inventors demonstrate that when the catalyst of the present invention is in the form of a carrier comprising cerin and includes at least two promoters, and when said catalyst is also activated by cold plasma before initiating the conversion reaction, the performance of the reaction is significantly greater than that achieved without prior activation of the catalyst, or when the catalyst does not comprise a copper promoter, or when the catalyst does not include at least two promoters.

In the context of the present invention, the promoter is in any of its oxidation states and in particular in metallic form or in oxide form.

Promoters act as doping agents and impact the physicochemical, textural and conductive properties of the catalytic system. The promoters according to the invention advantageously possess suitable surface physicochemical properties to help bind the reagents, as well as suitable dielectric properties that make it possible to improve the conductivity of the resulting catalyst and that lead to high CO conversion rates.

Thus, in the context of the present invention, said first promoter comprises copper. In the context of the present invention, the copper is in any of its oxidation states and in particular in metallic form or in oxide form (CuO or Cu₂O). The mass content of copper in the catalyst advantageously varies between 1% and 50% by weight relative to the weight of the carrier, for example between 2 and 40% by weight, preferably less than 30%. Particularly advantageously, the catalyst comprises between 5 and 16% by weight of copper or between 7 and 13% by weight of copper, for example about 10%±1% by weight of copper, relative to the weight of the carrier.

According to the present invention, the catalyst comprises at least one second promoter selected from the group consisting of transition metals, post-transition metals, lanthanides, and mixtures thereof, each being independently in metallic form or in oxide form.

Thus, in the context of the present invention, the at least one second promoter is selected from the group consisting of transition metals such as zinc and iron, post-transition metals such as aluminium and gallium, lanthanides such as lanthanum, and mixtures thereof. In the context of the present invention, the at least one second promoter is in any of its oxidation states and in particular in metallic form or in oxide form.

In the context of the present invention, the transition metals may in particular be selected from the group consisting of cobalt, silver, iron, copper, molybdenum, vanadium, manganese, chromium, yttrium, titanium, tantalum, zinc and zirconium. When the promoter is a transition metal, this is preferably iron or zinc, and even more preferably zinc.

In the context of the present invention, the post-transition metals may be selected from the group consisting of gallium, indium, tin, thallium, lead, bismuth, and aluminium. When the promoter is a post-transition metal, this is preferably gallium or aluminium, and even more preferably aluminium.

In the context of the present invention, the lanthanides may be selected from the group consisting of lanthanum, cerium, praseodymium, neodymium, promethium, samarium, europium, gadolinium, terbium, dysprosium, holmium, erbium, thulium, ytterbium and lutetium. When the promoter is a lanthanide, this is preferably cerium or lanthanum, and even more preferably lanthanum.

According to one embodiment of the present invention, the at least one second catalyst promoter is selected from the group consisting of zinc, iron, lanthanum, gallium, aluminium, and mixtures thereof, each being independently in metallic form or in oxide form. More preferably, the at least one second promoter is selected from the group consisting of zinc, aluminium, and mixtures thereof, each being independently in metallic form or in oxide form.

According to one embodiment, the catalyst preferably comprises two or three promoters. According to this embodiment, the catalyst is bimetallic or trimetallic. Preferably, the bimetallic or trimetallic catalyst consists essentially of a carrier comprising cerin and/or cerium oxide, and two or three promoters, the first of which comprises copper (in metallic or oxide form), and the second, and optionally the third, promoter(s) comprise zinc, iron, lanthanum, gallium, aluminium or mixtures thereof (each of these metals being independently in metallic or oxide form).

According to one embodiment, the catalyst does not comprise noble, rare precious materials, such as gold (Au) or platinum (Pt), or comprises an amount of these materials not significantly impacting its properties. Thus, according to this embodiment, the catalyst comprises less than 3% by weight of noble, rare or precious materials, less than 2% by weight, less than 1% by weight, less than 0.5% by weight, less than 0.1% by weight, or even less than 0.01% by weight of noble, rare or precious materials. Indeed, in the context of the present invention, it makes use of less expensive materials compared to thermal processes, which often use noble, rare or precious materials, such as gold or platinum.

According to one embodiment of the present invention, the promoter mass content varies between 0.1% and 40% by weight relative to the weight of the carrier, for example between 0.2% and 30% by weight, in particular between 0.3% and 20% by weight, preferably between 0.5% and 15% by weight, in particular between 1% and 12% by weight, even more preferably between 2% and 11% by weight relative to the weight of the carrier.

According to the present invention, the catalyst according to the present invention comprises at least two promoters, i.e. two or more promoters, for example three promoters. According to one embodiment, when the catalyst is trimetallic, doped with 3 promoters, one of which is copper (in metallic or oxide form), its mass content in the catalyst may vary preferably between 8 and 15%±0.2% by weight relative to the weight of the carrier; the second promoter may in particular be zinc (in metallic or oxide form), and its mass content in the catalyst may preferably vary between 3% and 8%±0.5% by weight relative to the weight of the carrier; the third promoter may in particular be aluminium (in metallic or oxide form) and its mass content in the catalyst may preferably vary between 1% and 5%±0.5% by weight relative to the weight of the carrier.

According to a particular embodiment, the trimetallic catalyst consists of three promoters, one of which is copper (in metallic or oxide form), its mass content in the catalyst is preferably about 10%±0.2% by weight relative to the weight of the carrier; the second promoter is zinc (in metallic or oxide form), and its mass content in the catalyst is preferably about 5%±0.5% by weight relative to the weight of the carrier; the third promoter is aluminium (in metallic or oxide form), its mass content in the catalyst is preferably about 3%±0.5% by weight relative to the weight of the carrier.

The catalyst inserted in the reactor forms a bed and can be in different forms (beads, monoliths, powders, etc.). In the case of powders, the grains forming the powder may for example have an average size between 1 μm and 1 mm, for example between 100 μm and 1 mm, in particular between 200 μm and 800 μm, preferably about 600 μm+20 μm. In particular, the grain size can be adapted according to the production scale used. The catalyst may also be in the form of beads (in particular by compressing the powder in a mould) having an average size of less than 5 cm.

According to one embodiment of the present invention, the carrier comprising cerin or cerium oxide, and the at least two promoters form a homogeneous mixture. This means that the promoters are evenly distributed over the entire volume of the catalyst.

### Method of Preparation of the Catalyst

The catalyst according to the present invention may be prepared according to different methods.

The catalyst may in particular be prepared by a method comprising putting the carrier comprising cerin or cerium oxide in contact with a precursor of the first copper promoter and at least one precursor of the second promoter. This step makes it possible to form a solid comprising the carrier, the copper and the second promoter (or promoters). The method optionally comprises a step of calcination of the mixture thus obtained. The step of putting them in contact may be preceded by a step of modification of the carrier. Furthermore, the optional calcination step is optionally followed by a step of reducing the calcined mixture. The reduction step may be performed in situ in the non-thermal plasma device under hydrogen.

The step of putting the carrier in contact with a copper precursor and a precursor of the second promoter can be carried out by several preparation methods, for example by impregnation, by coprecipitation or by other methods such as the sol-gel reaction or the hydrothermal method, thus putting the carrier in contact with a copper precursor and a precursor of at least one second promoter. The first two specific embodiments (also called sub-variants) are described below in more detail.

The precursor of the copper and the precursor of the second promoter may be any chemical compound, or mixture of chemical compounds, containing the metal used as the active metal/promoter, and more particularly may be a salt of said metal, an oxide of said metal or a mixture thereof, preferably a salt of said metal or a mixture of salts of said metal. The salt (denotes a non-hydrated salt or a hydrated salt, or even multi-hydrated salt) of said metal may for example be chosen from chloride, nitrate, sulphate, carbonate, acetate, acetylacetonate, tartrate, and citrate of said metal and mixtures thereof, preferably nitrate of said metal. In the case where the promoter is a mixture of several metals, the precursor may be a mixture of different types of salts and/or oxides of those metals.

Thus, according to a first alternative embodiment of the method according to the invention, the method for preparing a catalyst according to the invention comprises:
a step of putting the carrier comprising cerin or cerium oxide in contact with a copper precursor and one or more precursors of the promoter(s), and
optionally, a step of calcination of the mixture obtained after putting the components in contact with each other,
optionally, a step of reducing the calcined mixture obtained in the previous step.

According to a second alternative embodiment of the method according to the invention, the method for preparing a catalyst according to the invention comprises:
a step of putting the carrier comprising cerin or cerium oxide in contact with a copper precursor and one or more precursors of the promoter(s), and
a step of calcination of the mixture obtained after putting the components in contact with each other,
optionally, a step of reducing the calcined mixture obtained in the previous step.

According to a third alternative embodiment of the method according to the invention, the method for preparing a catalyst according to the invention comprises:
a step of putting the carrier comprising cerin or cerium oxide in contact with a copper precursor and one or more precursors of the promoter(s), and
a step of calcination of the mixture obtained after putting the components in contact with each other,
a step of reducing the calcined mixture obtained in the previous step.

According to a fourth alternative embodiment of the method according to the invention, the method for preparing a catalyst according to the invention comprises:
a step of modifying the carrier comprising alumina, and
a step of putting the modified carrier in contact with a copper precursor and one or more precursors of the promoter(s),
optionally a step of calcination of the mixture obtained after putting the components in contact with each other,
optionally, a step of reducing the calcined mixture obtained in the previous step.

The step of putting the components in contact with each other may in particular be carried out by impregnation. More specifically, according to this first sub-variant embodiment, the method comprises the following steps:
1) a step of preparing the carrier, and
2) a step of putting the components into contact with each other by impregnation.

Step 1) of preparation of the carrier itself comprises the following sub-steps:
1.1) preparing a suspension comprising a cerin precursor or comprising a cerium oxide precursor.

According to this step 1.1), the carrier precursor corresponds to a cerin precursor or a mixture of several precursors. In the case where the carrier is a mixture, in particular a mixed oxide, of cerium and alumina, a suspension of cerium precursor and a suspension of alumina precursor are advantageously prepared separately and then mixed in a ratio allowing the desired Ce/Al molar ratio to be obtained in the mixture, in particular the mixed oxide of cerium and final alumina.
1.2) mixing the suspension resulting from step 1.1).

In particular, these precursors are added at room temperature, for example between 20 and 25 °C, with continuous mixing for 30 min to several hours, for example for 30 min to 3h.
1.3) recovery of the solid obtained in step 1.2) by removing the excess water, in particular by evaporation of the water or filtration, then drying the resulting solid.

The drying step may in particular be carried out at a temperature below 150 °C, typically at a temperature of about 100 °C, for example for a duration varying between 5 h and 48h.
1.4) calcination of the solid resulting from step 1.3) to lead to the carrier.

The product resulting from step 1.3) is calcined, for example at a temperature between 300 °C and 600 °C. This calcination step can be carried out for 3 h or more, for example for a duration varying between 3 h and 6h. This step results in the thermal decomposition of nitrates to produce oxides.

The step 2) of putting the components into contact with each other itself comprises the following sub-steps:
2.1) preparing an aqueous suspension comprising a copper precursor and one or more precursors of the promoters.

During this step, a suitable mass of each precursor is added to a suitable volume of solvent, for example water. “Appropriate mass” and “appropriate volume” means the appropriate amounts of precursors and solvents (notably water) to obtain the desired mass contents of copper and promoter in the final catalyst.
2.2) adding the carrier resulting from step 1) to the aqueous solution resulting from step 2.1) to give a suspension.
2.3) mixing the suspension resulting from step 2.2).

The addition of these precursors is carried out at room temperature, for example between 20 and 25 °C, with continuous mixing for 30 min to several hours, for example for 30 min to 3h.
2.4) recovering the solid comprising the carrier, copper and promoters obtained in step 2.3) by removing the excess water, in particular by evaporation of the water or filtration, then drying the resulting solid.

The drying step may be carried out for example at a temperature below 150 °C, typically at a temperature of about 100 °C, for example for a duration ranging from 7 h to 48 h.
2.5) calcination of the solid resulting from step 2.4) to lead to the catalytic system.

The product resulting from step 2.4) is calcined, for example at a temperature between 300 °C and 600 °C. This calcination step can be carried out for 3 h or more, for example for a duration varying between 3 h and 6h. This step results in the thermal decomposition of nitrates to produce oxides.

This first sub-variant embodiment is also called a wet impregnation method. It consists of impregnating the carrier with the copper precursor and the promoter precursor.

The step of putting the components into contact with each other may alternatively be carried out by coprecipitation. More specifically, according to a second sub-variant embodiment, the method for preparing the catalyst comprises:
1′) a step of preparing the carrier, and
2′) a step of putting the carrier into contact with a copper precursor and the promoter, this putting the components into contact with each other being carried out by co-precipitation.

The carrier preparation step 1′) consists of preparing an aqueous solution comprising a copper precursor and the precursors of the promoters. This step is identical to step 2.1) of the wet impregnation method described previously.

The step 2′) of putting the components into contact with each other itself comprises the following sub-steps:
2.1′) addition of the carrier to the solution resulting from step 1′) to give a suspension This step is identical to step 2.2) of the wet impregnation method described previously.
2.2′) addition of a base to the suspension resulting from step 2.1′).

During this step, a base is added to the suspension resulting from step 2.1′). This base is advantageously a hydroxide salt, such as sodium hydroxide, potassium hydroxide, sodium carbonate or potassium carbonate, preferably sodium hydroxide. It may be used in the form of a solution, in particular aqueous. The base is added gradually drop by drop until the pH of the suspension (consisting of a solid suspended in a liquid solution) is between 8 and 12, preferably about 10. Step 2.2′) may be carried out at a temperature between 60 °C and 100 °C, in particular between 70 °C and 90 °C, preferably about 80 °C.
2.3′) mixing the suspension resulting from step 2.2′).

This step aims to precipitate the copper hydroxide and the hydroxide of the metal used as another promoter on the surface of the carrier. The mixing, in particular by stirring, is for example carried out at a temperature between 60 °C and 100 °C, preferably about 80 °C. This mixing step can be carried out for a duration of 2 h or more, typically for about 3h.
2.4′) recovery of the solid comprising the carrier, copper and promoter obtained in step 2.3′) and calcination thereof to lead to the catalytic system.

This step is identical to step 2.5) of the wet impregnation process.

This second sub-variant embodiment makes it possible to precipitate copper hydroxide and hydroxide of the metal used as promoter on the surface of the carrier.

Optionally, the step of putting the components into contact with each other may also be carried out by other preparation methods such as the sol-gel reaction or the hydrothermal method, thereby putting the carrier in contact with a copper precursor and a precursor of at least one second promoter.

### Use of the Catalyst According to the Present Invention

The present invention also relates to the use of a catalyst and a cold plasma for converting a gas mixture comprising carbon monoxide (CO) and water vapour (H₂O) according to the following WGS reaction: CO+H₂O→CO₂+H₂, said catalyst comprising at least one carrier comprising cerin or cerium oxide, at least one promoter comprising copper, and at least one second promoter selected from the group consisting of transition metals, post-transition metals, lanthanides, and mixtures thereof, said catalyst being further activated by cold plasma before being put into contact with the gas mixture to be converted.

The present invention relates in particular to the use of the catalyst of the present invention, as well as a cold plasma, preferably a plasma generated by dielectric barrier discharge (DBD), to convert a gas mixture comprising carbon monoxide (CO) and water vapour (H₂O) according to the WGS reaction.

Indeed, the inventors have realised that the combination of a catalyst according to the present invention, and a cold plasma, preferably a plasma generated by dielectric barrier discharge (DBD), showed increased efficiency in converting a gas mixture comprising carbon monoxide (CO) and water vapour (H₂O) according to the WGS reaction, particularly when the catalyst has been activated by cold plasma before being put into contact with the gas mixture to be converted.

The present invention also relates to the use of the catalyst according to the invention for the production of dihydrogen (H₂), from a gas mixture comprising carbon monoxide (CO) and water vapour (H₂O) according to the WGS reaction.

### LIST OF DOCUMENTS CITED

[1] W. Uribe-Soto, J.-F. Portha, J.-M. Commenge, and L. Falk, “A review of thermochemical processes and technologies to use steelworks off-gases,” Renew. Sustain. Energy Rev., vol. 74, no. Supplement C, pp. 809-823 July 2017.
[2] T. L. LeValley, A. R. Richard, and M. Fan, “The progress in water gas shift and steam reforming hydrogen production technologies-A review,” Int. J. Hydrog. Energy, vol. 39, no. 30, pp. 16983-170 October 2014.
[3] Dejiang Zhou; Renwu Zhou; Rusen Zhou; Baowang Liu; Tianqi Zhang; Yubin Xian; Patrick J. Cullen; Xinpei Lu; Kostya (Ken) Ostrikov; (2021). Sustainable ammonia production by non-thermal plasmas: Status, mechanisms, and opportunities. Chemical Engineering Journal, https://doi.org/doi: 10.1016/j.cej.2021.129544
[4] Jingjing Li, Sarayute Chansai, Christopher Hardacre and Xiaolei Fan, Non thermal plasma assisted water-gas shift reactions under mild conditions: state of the art and a future perspective, Catalysis Today, (2022) https://doi.org/10.1016/j.cattod.2022.11.017
[5] Amit K Jaiswal et al 2020 J. Phys. D: Appl. Phys. 53 465205, https://doi.org/10.1016/j.cattod.2022.11.017
[6] Wangkawong, K., Phanichphant, S., Inceesungvorn, B. et al. Kinetics of Water Gas Shift Reaction on Au/CeZr04: A Comparison Between Conventional Heating and Dielectric Barrier Discharge (DBD) Plasma Activation. Top Catal 63, 363-369 (2020). https://doi.org/10.1007/s11244-020-01245-8
[7] Xu, S., Chansai, S., Stere, C. et al. Sustaining metal-organic frameworks for water-gas shift catalysis by non-thermal plasma. Nat Catal 2, 142-148 (2019). https://doi.org/10.1038/s41929-018-0206-2
[8] Miriam González-Castaño; Bogdan Dorneanu; Harvey Arellano-García; (2021). The reverse water gas shift reaction: a process systems engineering perspective. Reaction Chemistry &amp; Engineering, https://doi.org/10.1039/dOre00478b
[9] Patent application US 2007/059235 A1-GM Global Technology Operations LLC
[10] US Patent Application 2008/131744 A1-Tetros Innovations LLC
[11] Patent EP 1866083 B1-University of REGINA
[12] Patent application WO 2013/110716 A1-SGE Scandgreen Energy AB
[13] Chen, F. F. (1984). “Introduction to Plasma Physics and Controlled Fusion.” Springer. ISBN: 978-O-306-41332-9.
[14] Fridman, A. (2008). “Plasma Chemistry.” Cambridge University Press. ISBN: 978-0521886678.

### EXAMPLES

The invention is now described in more detail with reference to the following examples, the purpose of which is merely illustrative and not intended to limit the scope of the invention.

### A. Preparation of the Various Catalysts by Wet Impregnation

The various catalytic systems are prepared by wet impregnation.

Different carriers were used to prepare the catalysts in Tables 1 and 2 below:
1) A commercial cerium oxide from Solvay—Nre002 (Ce);
2) A commercial aluminium oxide from Saint Gobain (Al200, Specific area=200 m²/g);
3) A commercial mixed cerium-zirconium oxide from Sigma Aldrich (CZ); and
4) A mixed cerium-aluminium oxide of molar composition Ce_{0.5}Al_{0.5}O₂, and synthesised by the inventors according to the method described above.

The catalytic systems doped by the copper-based promoter, and by the other promoter(s), are prepared from an aqueous solution comprising Cu(NO₃)₂·3H₂O (Sigma-Aldrich) and one or more promoter precursors chosen from Zn(NO₃)₂·6H₂O, Al(NO₃)₃·9H₂O, La(NO₃)₂·6H₂O, and Ga(NO₃)₂·xH₂O, Fe (NO₃)₂·9H₂O (all commercial, Sigma-Aldrich).

The salts of the promoter precursor(s) are dissolved in a volume of 50 ml of water, at room temperature and while stirring. The appropriate carrier mass is added to the aqueous solution containing the metal salt mixture and kept under stirring for 2 hours. In the case of the catalyst “10% Cu 5% Zn 3% Al/Ce” (one of the catalysts according to the invention), the content of Cu promoter is 10% by weight relative to the weight of the carrier, that of Zn promoter is 5% by weight relative to the weight of the carrier, and that of Al promoter is 3% by weight relative to the weight of the carrier. Thus, 0.38 g of copper nitrate (representing a content of 10% by weight of copper relative to the weight of the carrier), 0.227 g of zinc nitrate (representing a content of 5% by weight of zinc relative to the weight of the carrier), 0.417 g of aluminium nitrate (representing a content of 3% by weight of aluminium relative to the weight of the carrier), and 1 g of Ce carrier are mixed. The mixture is then placed in a rotary evaporator at 65 °C, in order to remove excess water.

After impregnation and evaporation of the water, all samples are collected, dried in an oven at 100 °C for 8 h, then calcined under air at 550 °C for 4 h with a temperature ramp of 10 °C/min. After calcination, the samples are hand-milled and sieved to an average grain size of between 50 and 200 μm.

### B. Conversion of a Gas Mixture Consisting of Carbon Monoxide (CO) and Water Vapour (H₂O) According to the WGS Reaction in the Presence of the Different Catalysts

An example of a procedure followed for the production of hydrogen as disclosed in the present invention is as follows: 471 mg of catalyst “10% Cu 5% Zn 3% Al/Ce” is placed between the electrodes of the DBD reactor. A non-thermal dielectric barrier discharge (DBD) plasma is then created between the two electrodes: a cylindrical copper electrode placed inside an alumina tube (3 mm diameter), surrounded by a coaxial quartz tube (10 mm internal diameter, 1 mm thickness), and a steel wire wound around the outer surface of the quartz tube, acting as a earth electrode (earthed via a 2 nF external capacitor). In this configuration, a discharge is sustained in a space of 2.5 mm, covering a length of about 1 cm. The catalyst is then activated in situ under non-thermal DBD plasma under H₂ as discharge gas for a duration of 60 minutes.

The reactor is then fed with a mixture of gas containing carbon monoxide and water vapour. The total gas flow rate used during the process is 100 ml/min STP (Standard Temperature and Pressure) at atmospheric pressure and at a temperature of 20 °C, corresponding to a GHSV (Gas Hourly Space Velocity) of 17000 h⁻¹. The H₂O/CO molar ratio is 1/1. The water is first propelled by an inert gas (Ar) and then flows through a mass flow meter. It is then vaporised and mixed with carbon monoxide using a controlled evaporation and mixing system (Bronkhorst MFC). The gas mixture is then transported along a heated pipe to the inside of the DBD plasma reactor.

The activity and selectivity of the different catalysts tested are measured and reported in Tables 1 and 2.

The experiments carried out and illustrated in Table 2 were conducted using an isothermal reactor surrounded by a jacket heated by an oil circulation heating system at 250 °C. A Julabo oil circulator for controlling the reactor temperature by pumping thermal oil through a circulation system.

The following equations were used to estimate catalytic performance and calculate CO conversion, H₂ and CO₂ selectivity:

$${X}_{CO} ( \% ) = \frac{{F}_{CO}^{in} - {F}_{CO}^{out}}{{F}_{CO}^{in}} \times 100 \qquad ( Eq . 3 )$$

$${S}_{H 2} ( \% ) = \frac{{F}_{{H}_{2}}^{out}}{{F}_{{CH}_{4}}^{out} + {F}_{{H}_{2}}^{out}} \times 100 \qquad ( Eq . 4 )$$

$${S}_{{CO}_{2}} ( \% ) = \frac{{F}_{{CO}_{2}}^{out}}{{F}_{{CH}_{4}}^{out} + {F}_{{CO}_{2}}^{out}} \times 100 \qquad ( Eq . 5 )$$

where Fⁱⁿ and F^{out} respectively denote the inlet and outlet flow rate (mol/s) of the species in question at the inlet and outlet of the reactor.

### C. Results

Table 1 below lists the catalysts tested in these tests (“c” indicates a comparative catalyst; “i” indicates a catalyst according to the invention) and indicates the results of the catalytic activity obtained in terms of conversion of CO and selectivity of H₂ and CO₂.

TABLE 1
Results of WGS reaction - composition of catalyst

| # | Catalyst | CO conversion [%] | H₂ selectivity [%] | CO₂ selectivity [%] |
|---|---|---|---|---|
| 1c | 10% Cu/Al200 | 50.57 | 99.33 | 99.33 |
| 2c | 10% Cu/CZ | 60.49 | 99.74 | 99.75 |
| 3c | 10% Cu/CeAl200 (50-50) | 52.01 | 99.86 | 99.86 |
| 4c | 20% Cu/CeAl200 (50-50) | 62.81 | 99.78 | 99.77 |
| 5c | 20% Cu/Ce | 62.35 | 99.62 | 99.63 |
| 6c | 15% Cu/Ce | 49.18 | 99.61 | 99.62 |
| 7c | 10% Cu/Ce | 69.91 | 99.81 | 99.81 |
| 8c | 7.5% Cu/Ce | 45.03 | 99.77 | 99.78 |
| 9c | 5% Cu/Ce | 36.03 | 99.71 | 99.72 |
| 10c | 1% Cu/Ce | 14.91 | 99.83 | 99.84 |
| 11c | 10% Ni/Ce | 32.12 | 78.21 | 87.01 |
| 12c | 5% Zn 3% Al/Ce | 13.84 | 99.73 | 99.74 |
| 13i | 10% Cu 5% La/Ce | 66.88 | 99.88 | 99.88 |
| 14i | 10% Cu 5% Zn/Ce | 66.29 | 99.75 | 99.76 |
| 15i | 10% Cu 5% Fe/Ce | 60.68 | 99.74 | 99.75 |
| 16i | 10% Cu 5% Ga/Ce | 48.55 | 99.91 | 99.91 |
| 17i | 10% Cu 5% Al/Ce | 65.53 | 99.83 | 99.83 |
| 18i | 10% Cu 2% Ga/Ce | 58.40 | 99.81 | 99.82 |
| 19i | 10% Cu 2% Zn/Ce | 64.46 | 99.87 | 99.88 |
| 20i | 10% Cu 3.2% Zn 1.5% Al/Ce | 67.65 | 99.81 | 99.81 |
| 21i | 10% Cu 5% Zn 3% Al/Ce | 77.53 | 99.91 | 99.91 |
| 22i | 15% Cu 5% Zn/CeAl200 (50-50) | 37.26 | 99.48 | 99.50 |

TABLE 2
Results of WGS reaction with 10% Cu 5% Zn 3% Al/Ce catalyst - importance of plasma

| # | Conditions | CO conversion [%] | H₂ selectivity [%] | CO₂ selectivity [%] |
|---|---|---|---|---|
| 23c | T = 250 °C | 16.12 | 99.73 | 99.74 |
| | without cold plasma activation; | | | |
| | cold plasma reaction | | | |
| 24c | T = 250 °C | 6.48 | — | — |
| | with cold plasma activation; | | | |
| | reaction without plasma with | | | |
| | thermal heating | | | |
| 25c | T = 250 °C, | 2.01 | — | — |
| | without cold plasma activation; | | | |
| | reaction without plasma with | | | |
| | thermal heating | | | |

As shown in the results of Table 2, tests 24c and 25c, without cold plasma during the conversion reaction, no change in the composition of the output gases is observed (very slight conversion). When the plasma is switched on, and after stabilisation, hydrogen production is obtained at the reactor outlet-Tables 1 and 2, tests 1 to 23. These results demonstrate the importance of combined plasma catalysis for the WGS conversion reaction. Furthermore, prior activation of the catalyst by cold plasma before it comes into contact with the gas mixture to be converted significantly improves the conversion efficiency (comparison of tests 21i and 23c in particular).

1. Method for converting a gas mixture comprising carbon monoxide (CO) and water vapour (H₂O) according to the following WGS reaction:
CO+H₂O→CO₂+H₂
characterised in that it is carried out in the presence of a cold plasma and a catalyst comprising:
a carrier comprising cerin or cerium oxide,
at least one first promoter comprising copper, in metallic form or in oxide form, and
at least one second promoter selected from the group consisting of transition metals, post-transition metals, lanthanides, and mixtures thereof, each being independently in metallic form or in oxide form,
said catalyst being activated by cold plasma before being put into contact with the gas mixture to be converted.

2. Method according to claim 1, wherein the second promoter is zinc and/or aluminium, each being independently in metallic form or in oxide form.

3. Method according to claim 1, wherein the catalyst contains at least 2% by weight of promoter comprising copper, relative to the total weight of the carrier.

4. Method according to claim 1, wherein the mass content of promoters varies between 0.1% and 40% by weight relative to the weight of the carrier.

5. Method according to claim 1, wherein the cold plasma is a plasma generated by dielectric barrier discharge (DBD).

6. Method according to claim 1, wherein the water vapour (H₂O)/carbon monoxide (CO) molar ratio in the gas mixture to be converted varies between 1 and 5.

7. Method according to claim 1, comprising the following steps in order:
a) Activating the catalyst placed between the electrodes of a cold plasma reactor, preferably a DBD plasma reactor, by generating cold plasma under H₂ as discharge gas;
b) Introducing the gas mixture to be converted through the catalyst between the reactor electrodes; and
c) The cold plasma conversion of the gas mixture according to the WGS reaction by circulating the gas stream between the reactor electrodes.

8. Catalyst for converting a gas mixture comprising carbon monoxide (CO) and water vapour (H₂O) according to the following WGS reaction:
CO+H₂O→CO₂+H₂
said conversion being performed in the presence of a cold plasma and said catalyst comprising
a carrier comprising cerin or cerium oxide,
at least one first promoter comprising copper, in metallic form or in oxide form, and
at least one second promoter selected from the group consisting of transition metals, post-transition metals, lanthanides, and mixtures thereof, each being independently in metallic form or in oxide form,
said catalyst being activated by cold plasma before being put into contact with the gas mixture to be converted.

9. Catalyst according to claim 8, wherein:
the catalyst comprises at least 5% by weight of promoter comprising copper, relative to the weight of the carrier; and/or
the catalyst comprises at least one second promoter selected from the group consisting of zinc, aluminium, and mixtures thereof, each being independently in metallic form or in oxide form.

10. Catalyst according to claim 8, comprising at least one second promoter consisting of zinc, in metallic form or in oxide form.

11. Catalyst of according to claim 8, wherein the mass content of promoters varies between 0.1% and 40% by weight relative to the weight of the carrier.

12. Catalyst according to claim 8, wherein the catalyst and the promoters form a homogeneous mixture.

13. Method of using a catalyst and cold plasma for the conversion of a gas mixture comprising carbon monoxide (CO) and water vapour (H₂O) according to the following WGS reaction:
CO+H₂O >CO₂+H₂
said catalyst comprising:
a carrier comprising cerin or cerium oxide,
at least one first promoter comprising copper, in metallic form or in oxide form, and
at least one second promoter selected from the group consisting of transition metals, post-transition metals, lanthanides, and mixtures thereof, each being independently in metallic form or in oxide form,
said catalyst being activated by cold plasma before being put into contact with the gas mixture to be converted.

14. Method according to claim 1, wherein the catalyst contains at least 5% by weight of promoter comprising copper, relative to the total weight of the carrier.

15. Method according to claim 1, wherein the mass content of promoters varies between 0.5% and 20% by weight relative to the weight of the carrier.

16. Method according to claim 1, wherein the cold plasma is a plasma generated by a DBD plasma reactor.

17. Method according to claim 1, wherein the water vapour (H₂O)/carbon monoxide (CO) molar ratio in the gas mixture to be converted varies between 1 and 3.

18. Catalyst according to claim 8, wherein the mass content of promoters varies between 0.5% and 20% by weight relative to the weight of the carrier.
